(19) United States
(12) Patent Application Publication
(10) Pub. No.: US 2025/0178961 A1
(43) Pub. Date: Jun. 5, 2025

(54) FIBER-REINFORCED STRUCTURES

(71) Applicant: SIKA TECHNOLOGY AG, Baar (CH)

(72) Inventors: Matthias GÖSSI, Uster (CH); Carsten RIEGER, Zürich (CH)

(73) Assignee: SIKA TECHNOLOGY AG, Baar (CH)

(21) Appl. No.: 18/839,250

(22) PCT Filed: Mar. 10, 2023
(86) PCT No.: PCT/EP2023/056136

§ 371 Date: Aug. 16, 2024

(30) Foreign Application Priority Data
Mar. 11, 2022 (EP) 22161670.9

(51) Int. Cl. C04B 20/10; C04B 14/38

(52) U.S. Cl. CPC C04B 20/1037; C04B 14/386; C04B 20/1033

(57) ABSTRACT

A fiber-reinforced structure, especially a fiber reinforced concrete structure, includes a multitude of composite fibers distributed within a matrix of a construction material, especially a mineral binder based construction material, whereby each composite fiber includes non-metallic load-bearing fibres kept by and/or embedded in an organic synthetic material, and whereby each composite fiber has a linear density of 25-500 tex, especially 50-350 tex.

### TECHNICAL FIELD

The invention relates to fiber-reinforced structures, especially fiber reinforced concrete structures, comprising of a multitude of composite fibers distributed within a matrix of a construction material. Furthermore, the invention is directed to a method for producing fiber-reinforced structures as well as the use of composite fibers as a reinforcement in a construction material, especially in concrete.

### BACKGROUND ART

Conventionally, in order to increase the tensile strength of structures made of construction materials such as e.g. concretes or mortars, the structures are reinforced with rebars made of steel.

Alternatively, structural reinforcement can be achieved with relatively short fibers that are randomly distributed within the construction material. Thereby, fibers of different materials can be used, e.g. fibers of steel, polymeric materials or even composite fibers. In comparison to strengthening with steel fibers, such composite fibers and polymeric fibers usually are non-corrosive, lighter than steel, easier to apply, and they lead to less wear in mixing and feeding devices.

For example, US 2021/0245456 A1 (USB I, LLC) describes improved composite fibers and structural materials mixed with these composite fibers. The fibers are produced by an improved process that vertically texturizes and impregnates resin into the fibers without introducing any substantial amount of microbubbles in the resin. By using vertical impregnation and twisting of fiber strands with specific viscosity control, stronger composite fibers, in which substantially no microbubbles are trapped, are produced with improved tensile strength and lower variance in tensile strength, for use in strengthening structural concrete and other structural materials.

However, producing such kind of composite fibers requires a rather complex multi-step process. In particular, several core fibers need to be texturized independently and subsequently twisted into a fiber strand in a resin impregnator by rotating the texturizers while resin having a well-defined viscosity is injected into the impregnator.

Furthermore, for concrete structures, for example, there are regulations for the type and the performance of the reinforcement. One of them is the FIB model code 2010, which describes the crack opening/force drop after the first crack in the brittle concrete matrix. The remaining force must not be below 40% of the maximum load before the crack (f_{R1}/f_{LK}>0.4).

While it is possible to produce concrete structures that fulfill the requirements of FIB Model code 2010 with conventional rebars and certain steel fibers, there are no satisfactory solutions known so far which are based on non-metallic reinforcements.

Thus, there is still a need for new and improved solutions that overcome the aforementioned disadvantages as far as possible.

### DISCLOSURE OF THE INVENTION

It is an object of the present invention to provide improved solutions for preparing reinforced structures, especially fiber-reinforced structures based on mineral binder compositions, in particular fiber-reinforced concrete structures. Especially, the solutions should allow for preparing concrete structures that fulfill the requirements of FIB Model code 2010 regarding crack opening. At the same time, the reinforced structures should be producible as easy as possible.

Surprisingly, it has been found that these objects can be achieved with the fiber-reinforced structures, methods and uses according to independent claims 1, 14 and 15.

Specifically, according to the invention, composite fibers comprising non-metallic load-bearing fibres kept together by and/or embedded in an organic synthetic material, and having a linear density of 25-500 tex, especially 50-350 tex, are used as reinforcement in fiber reinforced structures, especially fiber-reinforced structures based on mineral binder compositions, in particular reinforced concrete structures.

As it turned out, composite fibers comprising non-metallic load-bearing fibres kept together by an organic synthetic material, with a linear density of 25-500 tex, especially 50-350 tex, are highly beneficial reinforcements for fiber-reinforced structures, especially mineral binder based construction materials, such as e.g. fiber reinforced concrete.

A linear density of 25-500 tex, especially 50-350 tex, allows for producing sufficiently strong composite fibers with rather short lengths and high modulus of elasticity. Nevertheless, the composite fibers can be kept together and/or embedded within the matrix of the construction material such that sufficiently high pull-out forces result. This allows for providing fiber reinforces structures, in which—under sufficiently high load—the reinforcing composite fibers themselves or the matrix around the reinforcing composite fibers breaks rather than the reinforcing composite fibers are pulled out of the matrix.

Especially, concrete structures fulfilling the requirements of FIB Model code 2010 with regard to crack opening can be obtained without need for metallic components. Specifically, fiber reinforced structures in which the remaining force is at least 40% of the maximum load before the crack, i.e. f_{R1}/f_{LK}>0.4, can be provided when using the inventive composite fibers. Consequently, the inventive composite fibers can be used as a replacement for conventional metallic rebars or metallic fibers.

Especially, after selecting the type of construction material, e.g. the concrete type, and the type of composite fiber in terms of modulus of elasticity, tenacity, length, surface structure and/or pull-out forces, the minimum dose of composite fibers can be determined based on the requirement f_{R1}/f_{LK}>0.4.

Due to the special structure of the composite fibers, an effective reinforcement can be realized at dosages of the composite fibers that do not significantly affect processing of the construction material during production of the fiber-reinforced structure. Nevertheless, complete rupture of the composite fibers bridging a crack can be effectively prevented under typical loads.

Furthermore, the composite fibers can easily be added and be homogeneously mixed with mineral binder based construction materials when preparing the fiber-reinforced structures. Thanks to the organic synthetic material, which in certain embodiments forms a casing for the non-metallic load bearing fibers, wear off of the feeding and mixing equipment is reduced to a minimum.

Also, the composite fibers can be designed without any metallic components what is beneficial with regard to corrosion.

Particularly preferred embodiments are outlined throughout the description and the dependent claims.

### WAYS OF CARRYING OUT THE INVENTION

A first aspect of the present invention is directed to a fiber-reinforced structure, especially a fiber-reinforced structure based on a mineral binder composition, in particular a fiber-reinforced concrete structure, comprising of a multitude of composite fibers distributed within a matrix of a construction material, especially a mineral binder composition, in particular a concrete, whereby each composite fiber comprises non-metallic load-bearing fibres kept together by and/or embedded in an organic synthetic material, and whereby each composite fiber has a linear density of 25-500 tex, especially 50-350 tex.

A “fiber-reinforced structure” is meant to be a solid structure. The shape of the structure can be as desired. For example, the structure can be part of a building and/or an infrastructure construction, such as e.g. a street, a bridge, or a tunnel. For example, the structure is a ceiling, a wall, a roof, a floor, a support beam and/or a pillar.

The unit “tex” is a measure for the linear density of fibers, defined as the mass in grams per 1000 meters length.

The construction material in particular is meant to be a binder-based composition, which can be cured and/or hardened, especially with water. In the fiber-reinforced structure, the binder-based composition is present in cured and/or hardened state. The binder can be selected from mineral binders and/or organic binders.

The term “mineral binder” denotes, for example, a binder, which reacts in the presence of water in a hydration reaction to form solid hydrates or hydrate phases. The mineral binder may be, for example, a hydraulic binder, e.g., cement and/or hydraulic lime; a latent hydraulic binder, e.g., slag; a pozzolanic binder, e.g., fly ash; or a nonhydraulic binder, e.g. gypsum and/or white lime. The organic binder may for example be a synthetic resin dispersion and/or a one- or two-component reaction resin that, for example, hardens by polymerization.

The fiber-reinforced structure comprises a multitude of individual composite fibers. Thereby, the composite fibers are distributed within the construction material, which forms a contiguous matrix. Especially, the composite fibers are randomly distributed within the matrix of the construction material.

Each composite fiber comprises at least two non-metallic load-bearing fibers. These at least two non-metallic load-bearing fibres are kept together by the organic synthetic material. Although in a preferred embodiment, the non-metallic load-bearing fibers are fully embedded in the organic synthetic material, this is not compelling. For example, the non-metallic load-bearing fibers can be kept together only partly embedded in the surface of a common central core made of the organic synthetic material. Further preferred embodiments are discussed further below.

In particular, a modulus of elasticity of the composite fibers is at least as large as the modulus of elasticity of the matrix of the construction material. Thereby, the modulus of elasticity of the matrix of the construction material is meant to be the modulus of elasticity without the composite fibers. For mineral binder based construction material, the modulus of elasticity preferably is measured in line with standard DIN EN 12390-13:2021-09, 28 days after preparation of the construction material. The modulus of elasticity of the composite fibers can be measured according to standard ISO 527-3:2018.

If the modulus of elasticity of the composite fibers is adjusted in the above-described manner to the modulus of elasticity of the construction material, the elongation of the fibers right after failure of the matrix and before fiber pull-out starts in the reinforced fiber structure can be reduced and thereby the crack opening of the concrete structure can be effectively reduced. This is in sharp contrast to known synthetic reinforcement fibers.

Especially, the modulus of elasticity of the composite fibers equals at least 1.1 times, especially at least 1.5 times, in particular at least 2 times, the modulus of elasticity of the construction material.

Especially, a modulus of elasticity of the composite fibers is >40 GPa, in particular >50 GPa, for example >60 GPa.

This is in particular appropriate if the construction material is a mineral binder based composition, e.g. a concrete composition. In this case, for example, the construction material has a modulus of elasticity of 5-80 GPa, especially, 10-70 GPa, for example 15-60 GPa.

The non-metallic load bearing fibers can be selected from natural fibers, inorganic fibers and/or synthetic fibers.

For example, the non-metallic load bearing fibers are selected from carbon fibers, glass fibers, igneous rock fibers, basalt fibers, polyolefin fibers, aramid fibers, vectran fibers, polyhydroquinone-diimidazopyridine fibers (PIPD fibers; M5 fibers), poly(p-phenylen-2,6-benzobisoxazol) fibers (PBO fibers; Zylon).

Preferably, the load-bearing fibres comprise or consist of carbon fibers and/or synthetic fibers. Thereby, preferably, the synthetic fibers are selected from polyhydroquinone-diimidazopyridine fibers and/or poly(p-phenylen-2,6-benzobisoxazol) fibers. These kind of fibers turned out to be highly stable under alkaline conditions prevailing in mineral binder compositions, resulting in a long lasting and secure reinforcement of the fiber-reinforced structure.

Especially preferred, the load-bearing fibres comprise or consist of carbon fibers. Carbon fibers turned out to be optimal in terms of chemical stability, mechanical properties, and compatibility with organic synthetic materials for embedding.

Preferably, in the composite fibers, the non-metallic load-bearing fibres run in parallel and/or unidirectionally. This turned out to be optimal for load carrying. In particular, the non-metallic load-bearing fibres are not twisted, in particular not helically twisted.

Especially, each composite fiber comprises at least 5, in particular at least 10, preferably at least 25, for example at least 50, particularly at least 100, especially preferred at least 500, advantageously at least 800, non-metallic load-bearing fibers. For example, each composite fiber comprises 100-3000, especially 500-1500, non-metallic load-bearing fibers.

In particular, the organic synthetic material is a thermoset and/or a thermoplast.

Especially, the organic synthetic material may comprise a single material or a mixture of two or more materials.

For example, the organic synthetic material is selected from epoxy resins, polyurethane resins, polyester resins, vinyl-ester resins, epoxy vinyl ester resins, polyolefins, vinyl polymers, polyamide, polyvinyl alcohol, polyester, polyoxymethylene, polycarbonate, thermoplastic polyurethane, and/or ionomers.

Preferably, the organic synthetic material is selected from epoxy resins, epoxy vinyl ester resins, polyamide, polyvinyl alcohol, polyolefins, polyethylene terephthalate and/or poly(ethylene-vinyl acetate). These materials turned out to be highly suitable in the present context. Especially preferred are epoxy resins, epoxy vinyl ester resins, polyolefins and/or polyethylene terephthalate.

In particular, the epoxy resin and/or the epoxy vinyl ester resin is a one-component or a two-component curable resin. For example, a one-component resin comprises a latent curing agent, e.g., Dicyanamid. In this case, curing can be initiated by heating the resin to a predefined temperature.

According to a preferred embodiment, the organic synthetic material is selected from polyolefins and/or polyethylene terephthalate, preferably from polypropylene and/or polyethylene terephthalate glycol (PET-G), more preferably polypropylene.

Preferably, with respect to the total weight of a composite fiber, the composite fibers comprise 20-99 wt.-%, preferably 40-99 wt. %, especially 50-95 wt. %, of the non-metallic load-bearing fibres and 1-80 wt.-%, preferably 1-60 wt. % especially 5-50 wt. %, of the organic synthetic material.

In particular, the non-metallic load-bearing fibres are kept together in a shear-resistant manner. This means that the non-metallic load-bearing fibres in particular cannot move relative to each other.

Especially, the non-metallic load-bearing fibres are fully impregnated and embedded within the organic synthetic material. Thereby, rather stiff composite fibers can be produced, especially when using thermosets, e.g. epoxy resins, as organic synthetic material for embedding the load-bearing fibers and curing the thermosets.

According to another preferred embodiment, the composite fibers are configured as a core-shell structure with the non-metallic load-bearing fibres forming the core of the composite fibers and the organic synthetic material forming a casing around the core. Thereby, in particular, the non-metallic load-bearing fibres are only partly impregnated with the organic synthetic material, such that they can move relative to each other within the composite fibers.

In a direction perpendicular to the longitudinal direction, the composite fibers preferably have a circular, oval, elliptic, rectangular and/or quadratic cross-section.

Especially, the composite fibers have an oval, elliptic, and/or rectangular cross-section. Further preferred an aspect ratio of the height to the width of the cross-section is >1.5, especially >2, in particular >4. In particular, for non-rectangular cross-sections, the height is meant to be the maximum feret diameter of the cross-section whereas width is meant to be the minimum feret diameter of the cross-section.

A length of the composite fibers in particular is <75 mm, especially <30 mm and/or >2.5 mm, especially >5 mm. In particular, the composite fibers have a length of 2.5-75 mm, especially 5-40 mm or 20-35 mm.

A diameter of the composite fibers, especially the equivalent diameter determined according to EN 14889-2:2006 standard of the composite fibers, is for example from 0.05-2 mm, especially 0.1-1 mm.

Composite fibers with these lengths and/or diameters are in particular beneficial because they can for example easily be mixed with mineral binder compositions such that the composite fibers are homogeneously distributed and embedded within the mineral binder compositions. Due to the rather short length, the composite fibers hardly protrude out of the surface of the matrix of the construction material, what usually is undesired. In addition, clumping of fibers is reduced when compared with longer fibers. Nevertheless, despite the rather short length, the inventive composite fibers can be embedded within the matrix of the construction material such that sufficiently high pull-out forces and structural reinforcement are achievable. For special applications, other lengths and/or diameters might however be suitable as well.

According to an especially preferred embodiment, the composite fibers are configured as follows:
the load-bearing fibres comprise carbon fibers, basalt fibers, glass fibers and/or synthetic fibers, whereby the synthetic fibers are selected from aramid fibers, polyhydroquinone-diimidazopyridine fibers and/or poly(p-phenylen-2,6-benzobisoxazol) fibers; and
the organic synthetic material is selected from epoxy resins, polyamide, ethylene-vinyl acetate and/or epoxy vinyl ester resins; and
the composite fibers comprise 40-99 wt. %, especially 50-95 wt. %, of the load-bearing fibres and 1-60 wt. % especially 5-50 wt. %, of the organic synthetic material; and
the composite fibers have a length of 2.5-75 mm; and
the aspect ratio of the height to the width of the cross section is >1.5, preferably >2; and
the modulus of elasticity of the composite fibers preferably is >40 GPa, in particular >50 GPa, for example >60 GPa;

In a further preferred embodiment:
the load-bearing fibres comprise or consist of carbon fibers; and
the organic synthetic material is an epoxy resin and/or or an epoxy vinyl ester resin; and
the composite fibers comprise 40-99 wt. %, especially 50-95 wt. %, of the load-bearing fibres and 1-60 wt. % especially 5-50 wt. %, of the organic synthetic material; and
the composite fibers have a length of 2.5-75 mm; and
the aspect ratio of the height to the width of the cross section is >1.5, preferably at >2; and
the modulus of elasticity of the composite fibers preferably is >40 GPa, in particular >50 GPa, for example >60 GPa.

These specific configurations in particular result in highly beneficial composite fibers featuring a high chemical stability, advantageous mechanical properties and high durability in mineral binder compositions. However, other configurations might be suitable as well, in particular for special applications.

Preferably, the composite fibers are surface structured at their outer surfaces. Especially, the composite fibers comprise recesses and/or embossments in their outer surface and/or the outer surfaces of the composite fibers are coated with particles, e.g. sand particles. This can for example be achieved by embossing, grinding, sandblasting, crimping and/or coating, e.g. with sand particles.

In particular, the root-mean-square roughness Rq (λ=800 μm, 50 fold magnification) of the surface is from 1-80 μm, especially 3-60 μm or 5-40 μm. Rq is measured according to ISO 4287:1997.

Especially, the surface structure fulfills the following condition: Wq²/WSm=0.001-0.5 μm, in particular 0.005-0.20 μm, whereby Wq is the root-mean-square waviness Wq (2=250 μm, 10 fold magnification) and WSm is the waviness spacing. Wq and WSm are measured according to ISO 4287:1997.

Especially, the surface-structure is configured such that the pull-out force of the embedded composite fibers is increased when compared to an unstructured composite fiber.

In particular, the composite fibers do not comprise metallic materials, especially steel, in particular steel fibers.

The composite fibers can e.g. be produced by pultrusion. Thereby, for example, non-metallic load-bearing fibres are impregnated and/or coated using a die or a bath of the organic synthetic material used for embedding through which the non-metallic load-bearing fibres are pulled horizontally and/or vertically. Pultrusion processes for producing fibers are known to the skilled person.

In particular, the composite fibers are provided in the form of one or more fiber bundle(s). Thereby, preferably, in each bundle, a plurality of composite fibers are kept together by a wrapping, most preferred a water-soluble wrapping. This facilitates the production of the fiber-reinforced structure since the composite fibers can be added and mixed with the construction material in a highly controlled and efficient manner.

For example, in a bundle the composite fibers are kept together in parallel alignment.

Especially, a bundle may comprise for example 100-15,000, especially 1,000-10,000, composite fibers.

A water-soluble wrapping can for example be a water-soluble foil, e.g. made of polyvinyl alcohol. If the wrapping is made from a water-soluble foil, upon contact with mixing water of the construction material, the wrapping will dissolve in water and release the individual composite fibers, which can then be mixed homogeneously with the construction material.

Preferably, a content of the composite fibers in the matrix of the construction material is from 0.1-10 kg/m³, especially 0.5-5 kg/m³. Thereby, the volume in m³ is meant to be the volume of the construction material without fibers or before adding the fibers, respectively.

Especially, the density of fibers in the matrix of the construction material is chosen in the range of 50,000-2,000,000 composite fibers per m³, in particular 100,000-1,000,000 composite fibers per m³, 100,000-700,000 composite fibers per m³. Thereby, the volume in m³ is meant to be the volume of the construction material without fibers or before adding the fibers, respectively.

These contents and densities turned out to be optimal for reinforcing construction materials, especially mineral binder based construction materials, in particular concrete. However, depending on the requirements, other densities might be suitable as well.

In a special embodiment, the fiber-reinforced structure comprises at least one type of further fibers, which are chemically and/or physically different from the inventive composite fibers, wherein the further fibers are selected from metal fibers and/or synthetic fibers, especially synthetic fibers. This allows for further adjusting the desired properties of the fiber-reinforced structure.

In a preferred embodiment, the further fibers are synthetic fibers, preferably having a linear density of 100-800 tex, especially 250-750 tex and/or a length of not more than 75 mm, especially 20-65 mm.

Particularly, the content of the further fibers, especially synthetic fibers, in the matrix of the construction material is 0.1-10 kg/m³, especially 0.5-6 kg/m³.

Synthetic fibers are for example selected from polyethylene and/or polypropylene fibers. However, in a special embodiment, the fiber-reinforced structure does not comprise further fibers in the form of metallic fibers.

In particular, the construction material comprises or consists of a mineral binder composition, especially a cementitious mineral binder, in particular a concrete or mortar composition.

In particular, with respect to the total weight of the mineral binder, the mineral binder has a proportion of at least 5 wt. %, at least 20 wt. %, at least 35 wt. %, or at least 65 wt % of a hydraulic binder, for example, a cement. According to an exemplary embodiment, the mineral binder consists of at least 95 wt. % hydraulic binder, in particular cement. For example, the cement is of the CEM I, CEM II, CEM III, CEM IV or CEM V type (according to the standard EN 197-1).

However, the mineral binder can contain, or consist of, other binders. They are, for example, latent hydraulic binders and/or pozzolanic binders. Suitable latent hydraulic and/or pozzolanic binders are, for example, slag, fly ash and/or silica dust. Similarly, the construction material can contain inert substances, such as, for example, limestone, quartz powder and/or pigments. In an exemplary embodiment, the mineral binder contains 5-95 wt %, for example, 5-65 wt %, for example, 15-35 wt % latent hydraulic and/or pozzolanic binders. Advantageous latent hydraulic and/or pozzolanic binders are slag and/or fly ash.

In an exemplary embodiment, the mineral binder contains a hydraulic binder, in particular a cement, and a latent hydraulic and/or pozzolanic binder, preferably slag and/or fly ash. The proportion of the latent hydraulic and/or pozzolanic binder here can be 5-65 wt. %, especially 15-35 wt. %, and at least 35 wt. %, especially at least 65 wt. % hydraulic binder, e.g. cement.

In an additional exemplary embodiment, the construction material, especially the mineral binder composition, contains additional solid aggregates, for example, gravel, sand and/or rock aggregates. Corresponding compositions can be formulated for example as mortar or concrete compositions.

Especially, in uncured state, the mineral binder composition in addition contains water, wherein a weight ratio of water to mineral binder can be in the range of 0.25-0.8, for example, 0.3-0.6, for example, 0.35-0.5. Such binder compositions can be processed directly as mortar or concrete compositions.

Furthermore, the mineral binder composition may comprise at least one additive, for example, a concrete additive and/or a mortar additive. The at least one additive comprises, for example, a defoaming agent, a dye, a preservative, a plasticizer, a retarding agent, an air pore forming agent, a shrinkage reducing agent and/or a corrosion inhibitor or combinations thereof. Usually, such additives are present with a proportion of 0.0001-10 wt. %, with respect to the total weight of the mineral binder composition.

A second aspect of the present invention is directed to a method for producing a fiber-reinforced structure as described above, whereby composite fibers, especially in the form of one or more fiber bundle(s) as described above, are mixed with a construction material, especially a mineral binder based construction material, in particular concrete, whereby each composite fiber comprises non-metallic load-bearing fibres kept by and/or embedded in an organic synthetic material, and whereby each composite fiber has a linear density of 25-500 tex, especially 50-350 tex.

In the inventive method, the construction material, the non-metallic load-bearing fibres, the organic synthetic material for embedding the non-metallic load-bearing fibres, the composite fibers, the densities, lengths and diameters of the composite fibers in the construction material as well as any further features in particular are defined and configured as described above in connection with the first aspect.

Especially, when mixing the composite fibers with the construction material, the construction material is in a workable condition. In particular, if the construction material is a mineral binder composition, the mineral binder composition is present in non-hardened and workable state.

In particular, the composite fibers are homogeneously distributed, especially randomly distributed, within the construction material.

A content of the composite fibers in construction material in particular is from 0.1-10 kg/m³, especially 0.5-5 kg/m³.

Especially, the fiber dosage is selected depending on the desired bending strength of construction material, for example the concrete composition, and/or the fiber tensile strength. For a construction material with a higher desired bending strength, the fiber dosage is increased whereas for a fiber with higher tensile strength, the dosage is lowered.

A third aspect of the present invention is directed to the use of composite fibers as a reinforcement in a construction material, especially a mineral binder based construction materials, in particular concrete, whereby the composite fibers comprise non-metallic load-bearing fibres kept by and/or embedded in an organic synthetic material, and whereby each composite fiber has a linear density of 25-500 tex, especially 50-350 tex.

In the inventive use, the construction material, the non-metallic load-bearing fibres, the organic synthetic material for keeping and/or embedding the non-metallic load-bearing fibres, the composite fibers, densities, diameters, and any other features as well as the fiber reinforced structure and the method of production in particular are defined, configured and/or implemented as described above in connection with the first and the second aspect.

The composite fibers are in particular used for preparing fiber-reinforced structures, especially fiber reinforced structures based on mineral binder compositions, particularly preferred fiber reinforced concrete structures. Thereby, preferably, the fiber reinforced concrete structures fulfill the requirements of FIB Model code 2010 regarding crack opening.

Further advantageous implementations of the invention are evident from the exemplary embodiments.

### BRIEF DESCRIPTION OF THE DRAWINGS

The drawings used to explain the embodiments show:

FIG. 1A graph representing the post-cracking bending strength at various specified values of the opening of the preformed crack (CMOD), namely at 0.5, 1.5, 2.5 and 3.5 mm for various concrete specimens with and without composite fibers.

### EXEMPLARY EMBODIMENTS

### Materials

For the experiments, the following fibers listed in table 1 were used.

TABLE 1

| Property | R | F1 | F2 | F3 | F4 | F5 | F6 | F7 |
|---|---|---|---|---|---|---|---|---|
| Fiber Material | Steel | Carbon | | | | | | |
| Jacket (organic | — | PA²⁾ | Epoxy | | | PA²⁾ | EVA³⁾ | |
| synthetic | | | | | | | | |
| material) | | | | | | | | |
| Linear density | 550 | 100 | 100 | 100 | 350 | 300 | 82 | 82 |
| [tex] | | | | | | | | |
| Length [mm] | 12.5 | 33.5 | 33.5 | 25.4 | 33.5 | 33.5 | 33.5 | 25.4 |
| Structure¹⁾ | — | FI | CS | CS | FI | FI | CS | CS |

¹⁾FI = fibers fully impregnated and embedded within organic synthetic material; CS = Core-shell structure: fibres forming the core of the composite fibers and the organic synthetic material forming a casing around the core.
²⁾Polyamide (PA12)
³⁾Ethylene-vinyl acetate copolymer

Composite fibers F2, F3, F6 and F7 were produced with carbon fibers and epoxy/EVA in a standard pultrusion process, whereas fibers R, F1, F4 and F5 were purchased from Suprem SA (Switzerland; composite fibers F1 and F5), Suter-Kunststoffe AG (Switzerland; composite fibers F4; fibers produced by van Dijk Pultrusion Products) and Krampe Harex GmbH & Co. KG (Germany; fibers R).

### Preparation of Samples

Reference fibers R and composite fibers F1-F7 were tested in a standard concrete composition having a compressive strength of 60 MPa. Thereby, the respective fibers were added during preparation of the concrete composition together with standard polymer fibers (SikaFiber Force-40; available from Sika Switzerland) and mixed with the other components of the composition. A proportion of composite fibers F1-F7 was chosen such that in all tests a concentration of 400,000 composite fibers per m³ was obtained. For the reference sample, the proportion of steel fibers R was about 2,200,000 composite fibers per m³. The proportion of the standard polymer fibers were kept constant at 5 kg/m³ in all concrete composition. Therefore, the standard polymer fibers in all compositions have the same effect and do not influence comparisons between different concrete compositions.

From the so produced concrete compositions, beam specimens according to EN 14651:2005 were produced.

### Test Method

The flexural tensile strengths of the beam specimens were measured in accordance with EN 14651:2005 under a central line load. The test determines the residual (post-cracking) bending strength in MPa at various specified values of the opening of the preformed crack (CMOD), namely 0.5, 1.5, 2.5 and 3.5 mm, thus defining the falling branch of the load-deflection curve.

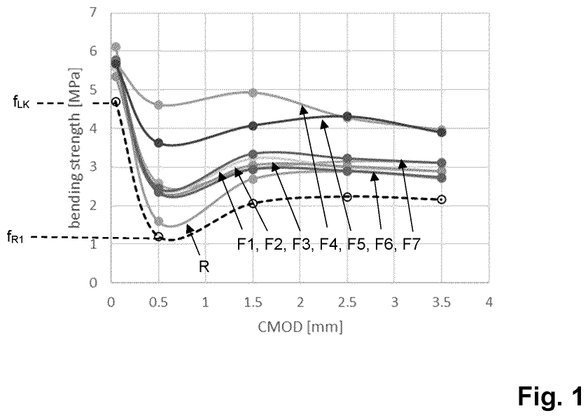

FIG. 1 shows the obtained results for fibers R and F1-F7. The dashed curve is a reference measurement only with standard polymer fibers (SikaFiber Force-40; 5 kg/m³) but without any other fibers.

As evident from FIG. 1, the addition of composite fibers F4 and F5 with 350 and 300 tex increased the ratio of f_{R1}/f_{LK} from 26% (reference without composite fibers) to 81% (F4) or 64% (F5), respectively. With composite fibers F1, F2, F3, F6 and F7, having a linear density of 100 tex, the ratio of f_{R1}/f_{LK} was still above the normative limit of 40%. In contrast, with steel fibers R, the ratio of f_{R1}/f_{LK} was well below 40%.

Thus, the composite fibers according to the present invention are highly suitable for producing concrete structures that fulfill the requirements of FIB Model code 2010.

It will be appreciated by those skilled in the art that the present invention can be implemented in other specific forms without departing from the spirit or essential characteristics thereof. The presently disclosed implementations and embodiments are therefore considered in all respects to be illustrative and not restricted.

1. A fiber-reinforced structure comprising a multitude of composite fibers distributed within a matrix of a construction material whereby each composite fiber comprises non-metallic load-bearing fibres kept together by an organic synthetic material, and whereby each composite fiber has a linear density of 25-500 tex.

2. The fiber reinforced structure according to claim 1, whereby the modulus of elasticity of the composite fibers measured based on ISO 527-3:2018 is at least as large as the modulus of elasticity of the matrix of the construction material, the modulus of elasticity of the matrix of the construction material measured according to EN 12390-13:2013.

3. The fiber reinforced structure according to claim 1, fulfilling the requirement f_{R1}/f_{LK}>0.4, wherein f_{R1} is the remaining force after first crack and f_{LK} is the maximum load before crack as defined in FIB model code 2010.

4. The fiber reinforced structure according to claim 1, whereby the load-bearing fibres comprise carbon fibers, basalt fibers, glass fibers and/or synthetic fibers, whereby the synthetic fibers are selected from aramid fibers, polyhydroquinone-diimidazopyridine fibers and/or poly(p-phenylen-2,6-benzobisoxazol) fibers.

5. The fiber reinforced structure according to claim 1, whereby the load-bearing fibres consist of carbon fibers.

6. The fiber reinforced structure according to claim 1, whereby the organic synthetic material is a thermoset and/or a thermoplast.

7. The fiber reinforced structure according to claim 1, whereby the organic synthetic material is selected from epoxy resins, epoxy vinyl ester resin, polyamide, polyvinyl alcohol, polyolefins, polyethylene terephthalate and/or poly(ethylene-vinyl acetate).

8. The fiber reinforced structure according to claim 1, whereby the organic synthetic material is selected from polyolefins and/or polyethylene terephthalate.

9. The fiber reinforced structure according to claim 1, whereby, with respect to the total weight of a composite fibers, the composite fibers comprise 20-99 wt. % of non-metallic load-bearing fibres and 1-80 wt.-% of the organic synthetic material.

10. The fiber reinforced structure according to claim 1, whereby in the composite fibers, the non-metallic load-bearing fibres are fully impregnated and embedded within the organic synthetic material.

11. The fiber reinforced structure according to claim 1, whereby the composite fibers are configured as a core-shell structure with the non-metallic load-bearing fibres forming the core of the composite fibers and the organic synthetic material forming a casing around the core.

12. The fiber reinforced structure according to claim 1, whereby the composite fibers, in a direction perpendicular to the longitudinal direction, have a circular, oval, elliptic, rectangular and/or quadratic cross-section, whereby, the composite fibers have an oval, elliptic, and/or rectangular cross-section with an aspect ratio of the height to the width is >1.5.

13. The fiber reinforced structure according to claim 1, whereby a length of the composite fibers is <75 mm and the length is >2.5 mm.

14. The fiber reinforced structure according to claim 1, whereby the composite fibers are surface-structured at their outer surfaces, in particular such that a root-mean-square roughness Rq (λ=800 μm, 50 fold magnification) of the surface is from 1-80 μm, whereby Rq is measured according to ISO 4287:1997.

15. The fiber reinforced structure according to claim 1, whereby a content of the composite fibers in the matrix of the construction material is from 0.1-10 kg/m³.

16. The fiber reinforced structure according to claim 1 further comprising at least one type of further fibers which are chemically and/or physically different from the composite fibers, wherein the further fibers are selected from metal fibers, glass fibers, basalt fibers and/or synthetic fibers.

17. The fiber reinforced structure according to claim 16, whereby the further fibers are synthetic fibers, having a linear density of 100-800 tex and/or a length of not more than 75 mm.

18. The fiber reinforced structure according to claim 16, whereby a content of the further fibers in the matrix of the construction material is 0.1-10 kg/m³.

19. The fiber reinforced structure according to claim 1, whereby the construction material is a concrete composition.

20. A method for producing a fiber-reinforced structure according to claim 1, whereby a multitude of composite fibers as defined in claim 1 in the form of one or more fiber bundle(s) each comprising a plurality of the composite fibers kept together by a water-soluble wrapping, are mixed with a construction material, whereby each composite fiber comprises non-metallic load-bearing fibres kept by and/or embedded in an organic synthetic material, and whereby each composite fiber has a linear density of 25-500 tex.

21. A construction material comprising composite fibers as defined in claim 1, as a reinforcement, whereby the composite fibers comprise non-metallic load-bearing fibres kept by and/or embedded in an organic synthetic material, and whereby each composite fiber has a linear density of 25-500 tex.
